(19) United States
(12) Patent Application Publication
(10) Pub. No.: US 2006/0101500 A1
(43) Pub. Date: May 11, 2006

(54) Broadcast DVD delivery service

(76) Inventors: Mike Arthur Derrenberger, Valencia, CA (US); Yousef Wasef Nijim, Valencia, CA (US)

Correspondence Address: THOMSON LICENSING INC., PATENT OPERATIONS, PO BOX 5312, PRINCETON, NJ, 08543-5312, US

(21) Appl. No.: 11/258,434

(22) Filed: Oct. 25, 2005

Related U.S. Application Data
(60) Provisional application No. 60/623,784, filed on Oct. 29, 2004.

(51) Int. Cl. H04N 7/025; H04N 7/173; H04N 7/10; G06F 3/00; G06F 13/00; H04N 5/445

(52) U.S. Cl. 725/87; 725/86; 725/42; 725/34

(57) ABSTRACT

This technique of the present principles provides a new business model for delivering network broadcast content to subscribers. The technique of the present principles accomplishes delivery to a subscriber of commercial free broadcast content on a DVD or other tangible media via regular mail service in advance of over-the-air broadcast. Using this technique, an over-the-air broadcaster can create a new premium sales window for the network broadcast content.

### CROSS-REFERENCE TO RELATED APPLICATION

This application claims priority under 35 U.S.C. 119(e) to U.S. Provisional Patent Application Ser. No. 60/623,784, filed Oct. 29, 2004 the teachings of which are incorporated herein.

### FIELD OF THE INVENTION

This invention relates to a method for delivery of video content to viewers.

### BACKGROUND ART

The proliferation of cable television networks and satellite-to-the home networks affords television viewers a wider choice of programming than ever before. Many cable television and satellite-to-the home networks offer subscribers a hundred or more separate channels of programming. Some of the channels, available at an extra cost, carry recently released movies, sporting events and other commercial free programming. Traditional over-the air networks in the United States, such as ABC, CBS, NBC, and FOX face growing competition from cable television networks and satellite-to-the home networks, in terms of the both the quality and variety of available content. Large foreign over-the air-networks, such as those in Europe, also face similar competition as well. In many instances, cable television networks and satellite-to-the home networks deliver visually superior content directly to subscribers, relative to over-the-air broadcast networks. However, as many over the air broadcast stations increase their High Definition programming, the perceived advantage of cable television networks and satellite-to-the home networks with regard to the image quality will disappear.

In addition to competition from cable television networks and satellite-to-the home networks, conventional over-the-air networks now face a financial threat from the emergence of Personal Video Recorders (PVRs). Such devices afford users the ability to record over-the-air content while skipping commercials. Presently, advertisers who pay over-the air networks to broadcast commercials do so based on ratings that reflect the estimated number of viewers watching a particular program containing such commercials. If a sizable number of viewers no longer watch the commercials, then advertisers will demand lower advertising rates, thus reducing network revenues.

Thus, there is need for a technique that affords an over-the air network the opportunity to offer viewers access to commercial-free content on a revenue-bearing basis.

### BRIEF SUMMARY OF THE INVENTION

Briefly, in accordance with a preferred embodiment of the present principles, there is provided a method for delivering to a subscriber video content recorded on a tangible medium. The method commences by recording onto the tangible medium at least one program selected in response to a subscriber request received prior to a first scheduled broadcast of such program. The tangible medium is then physically delivered to the subscriber in advance of the first scheduled broadcast. The subscriber is then charged an amount that varies with both with type and number of programs recorded on the tangible medium.

### BRIEF DESCRIPTION OF THE DRAWINGS

FIG. 1 depicts a time line illustrating the present day release window for over-the-air broadcast content;

FIG. 2 depicts a block diagram of a technique in accordance with the present invention for distributing over-the-air broadcast content in advance of the first scheduled broadcast date; and

FIG. 3 depicts a time line illustrating the release window for over-the-air broadcast content in accordance with the method of the technique of the present principles.

### DETAILED DESCRIPTION

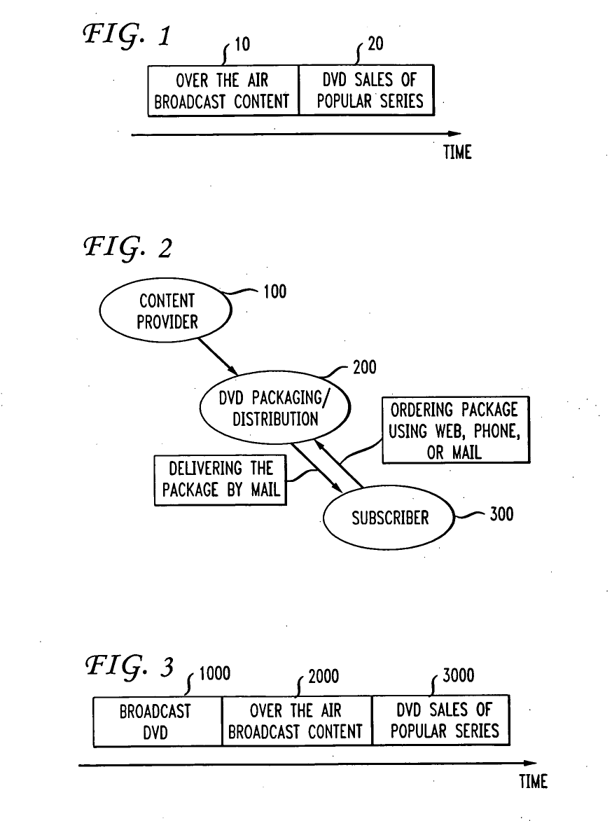

To understand better the technique of the present principles that provides for delivery of over-the-air broadcast content in advance of the first scheduled broadcast, consider the current method of content delivery whose time line appears in FIG. 1. Presently, an over-the-air broadcaster will show a particular program at a given time during step 10. For example, each episode of a serialized comedy or drama appears at a given on a given day of the week. Later, the content provider will commence sales of a collection of episodes on a tangible medium, such as a DVD, during step 20 of FIG. 1. Broadcast of the each episode of serialized program over the air always precedes the sale of the DVD that contains previously broadcast episodes of that program. In many instances, the initial offer for sale of the DVD does not occur broadcast after broadcaster has discontinued broadcasting the program altogether.

Many television programs have large numbers of viewers who watch on a regular basis. Because of busy schedules, some viewers cannot watch a particular episode at the time of scheduled broadcast. Currently such viewers can make use of videotape recorder, DVD recorder, or PVR to record missed episodes. Depending on the recording mechanism employed, the viewer can skip the commercials. The over-the-air broadcaster does not enjoy any additional revenue from such recordings, and indeed, widespread use of PVRs to record content without commercials could cause advertisers to reduce advertising payments.

FIG. 2 depicts a block diagram of a technique in accordance with the present principles for distributing over-the-air broadcast content on a revenue-bearing basis in advance of the first scheduled broadcast date. Thus, the present technique affords a subscriber direct access to content without commercials, thus providing nearly all the features of PVR based content. The distribution technique of FIG. 2 operates in the following manner. One or more providers of content 100, such as over-the-air broadcast networks, and/or movie studio or production companies that supply content for over-the-air broadcast, enter into a relationship with one or more entities 200 that replicate, package and distribute such content on a tangible media, like a DVD. The content providers 100 can include not only US over-the-air broadcast networks, but foreign networks as well. The entity 200 need not itself perform the replication, packaging and distribution functions itself, but could sub-contract performance of any or all of such functions to others, while maintaining oversight and coordination of such tasks.

The content distributed by, or under the control of the entity 200 comprises commercial-free television programming (e.g., comedy, drama, specials etc) scheduled for first broadcast over-the-air at a date subsequent to its availability for distribution to one or more subscribers 300. Subscribers 300 can order content from the entity 200 in a variety of different ways, such as by telephone, through the Internet by accessing the web site maintained by the entity 200, or by mail. Upon receipt of a request for one or more programs from a subscriber 300, the entity 200 (or one of more sub-contractors operating under its direction), will provide the requested content on a DVD or other tangible media for physical delivery to the subscriber. Such delivery typically occurs via the mail or via a delivery service, such as United Parcel Service, Federal Express or the like. The entity 200 (or one of its subcontractors) will debit the subscriber's account an amount that varies with both with type and number of programs recorded on the tangible medium delivered to the subscriber. Typically, such debiting occurs by charging the subscriber's credit card. Other techniques exist for charging the subscriber for such content. Physical distribution can occur not only in the United States, but in foreign countries as well, either by mail or courier delivery.

FIG. 3 depicts a time line illustrating the release window for over-the-air broadcast content delivered to the subscriber in accordance with the technique of the present principles. As shown in FIG. 3, distribution of content on tangible media to subscribers during step 1000 occurs prior to over-the-air broadcast of that content during step 2000. DVD sales of an entire season of episodes of a popular series typically occur during step 3000 after broadcast over-the-air during step 2000. Thus, as compared to the release window of FIG. 1, the release window of FIG. 3 commences with fee-based distribution of content to a requesting subscriber in advance of over-the-air broadcast of such content.

This technique of the present principles provides a new business model for delivering network broadcast content to subscribers. The technique of the present principles accomplishes delivery to a subscriber of commercial free broadcast content on a DVD or other tangible media via regular mail service in advance of over-the-air broadcast during a time slot typically based on advertisement revenue. Using the technique of the present principles, an over-the-air broadcaster can create a new premium sales window for the network broadcast content. The entity 200 of FIG. 2, which manages DVD replication packaging and distribution, can arrange for physical delivery of the content to the subscriber 300 of FIG. 2 on a regular basis (e.g., weekly, monthly, bimonthly etc.). The DVDs can contain content from different networks, either US and/or foreign (just as in the case of over-the-air broadcast) or content from a specific network. The content itself can be genre based (e.g., comedy, action, soap operas), time-slot based (e.g., Monday, Tuesday, etc.), or it can be based on content popularity (e.g., top ten shows across the network broadcasts). As discussed, the subscriber 300 selects the content in advance of broadcast over the air. The content could be pre-packaged or based on specific subscriber selection, and can exist on a standard DVD format or on HD-DVD or Blue Ray format or such other formats available in the future.

The above-described technique affords subscribers the ability to: (1) view commercial-free content whenever and wherever they want and (2) own a library of their favorite broadcast material, thus allowing subscribers the ability to customize their viewing. The content on the DVD can originate from different networks or from a specific network, with different packages available to subscribers at different prices, depending on the type and number of programs recorded on the DVD. In practice, the recording process employed to replicate content on a DVD affords higher quality than that associated with over-the-air content broadcast but less than conventional DVD quality to accommodate more content on a DVD taking into consideration that the current DVD could hold up to 4.4 Gigabytes.

The present technique eliminates the need for the subscribers to record content since the content comes pre-recorded. Moreover, content delivery to the home by mail or other carrier can occur whether the subscriber is present or not. Since the subscriber retains the content, the present technique reduces the need for a large infrastructure to receive and re-send content, as in the case when content is rented for a limited time.

The foregoing describes a technique for delivering commercial-free content to subscribers on a revenue-bearing basis in advance of over-the-air broadcast of such content.

1. A method for delivering to a subscriber video content recorded on a tangible medium, comprising the steps of:
recording onto the tangible medium at least one piece of content selected in response to a subscriber request received prior to a first scheduled broadcast of such piece of content;
physically delivering tangible medium containing the at least one piece of recorded content in advance of the first scheduled broadcast that piece of content; and
charging the subscriber an amount that varies with both with type and number of pieces of content recorded on the tangible medium.

2. The method according to claim 1 wherein step of recording the on the tangible medium further comprises the step of recording the piece of content on a DVD.

3. The method according to claim 1 wherein the subscriber request is received via telephone.

4. The method according to claim 1 wherein the subscriber request is received via physical mail.

5. The method according to claim 1 wherein the subscriber request is received via the Internet.

6. The method according to claim 1 wherein the step of physically delivering the at least one piece of recorded content further comprises the step of delivering the at least one piece of content via mail.

7. The method according to claim 1 wherein the step of physically delivering the at least one piece of recorded content further comprises the step of delivering the at least one piece of content via courier service.

8. The method according to claim 1 wherein the step of charging the subscriber further comprises the step of debiting the subscriber's credit card.

9. A method for delivering to a subscriber video content recorded on a DVD, comprising the steps of:
recording onto the DVD at least one piece of commercial-free content selected in response to a subscriber request received prior to a first scheduled over-the-air broadcast of such piece of content;
physically delivering the DVD in advance of the first scheduled broadcast that piece of content; and
charging the subscriber an amount that varies with both with type and number of pieces of content recorded on the DVD.

10. The method according to claim 9 wherein the subscriber request is received via telephone.

11. The method according to claim 9 wherein the subscriber request is received via physical mail.

12. The method according to claim 9 wherein the subscriber request is received via the Internet.

13. The method according to claim 9 wherein the step of physically delivering the DVD further comprises the step of delivering the DVD via mail.

14. The method according to claim 9 wherein the step of physically delivering the DVD further comprises the step of delivering the DVD via courier service.

15. The method according to claim 9 wherein the step of charging the subscriber further comprises the step of debiting the subscriber's credit card
